(19) United States
(12) Patent Application Publication
(10) Pub. No.: US 2026/0227033 A1
(43) Pub. Date: Aug. 6, 2026

(54) METHOD FOR ASCERTAINING THE FILL LEVEL OF A TANK UNIT, AND TANK UNIT FOR STORING A GASEOUS FUEL

(71) Applicant: Robert Bosch GmbH, Stuttgart (DE)

(72) Inventors: Stefan Kieferle, Stuttgart (DE); Birgit Lenz, Korntal (DE); Christian Schugger, Stuttgart (DE); Christian Kuhnert, Vaihingen/Enz (DE); Martin Schwab, Sindelfingen (DE); Nicolas Wussler, Esslingen Am Neckar (DE)

(21) Appl. No.: 19/149,453

(22) PCT Filed: Dec. 27, 2023
(86) PCT No.: PCT/EP2023/087843

§ 371 Date: Jul. 18, 2025

(30) Foreign Application Priority Data
Jan. 20, 2023 (DE) 10 2023 200 440.2

(51) Int. Cl. F17C 13/02; F17C 13/04; G01F 22/02

(52) U.S. Cl. CPC F17C 13/02; F17C 13/04; G01F 22/02; F17C 2205/0326; F17C 2205/0352; F17C 2250/0417; F17C 2250/043; F17C 2250/0439; F17C 2270/0168

(57) ABSTRACT

The present invention relates to a method for ascertaining the fill level of a tank unit having a plurality of tank vessels (TB), each of which are connected to a gas pipe system (GL) by a respective valve mechanism that can be switched between an open state and a closed state, wherein the method comprises reading a fill level of all tank vessels out of a data memory, said fill level having been ascertained and stored during a preceding operation of a vehicle; switching the valve mechanisms from the closed state to the open state such that gas can flow from the tank vessels into the gas pipe system; ascertaining a mass of gaseous fuel dispensed from the gas pipe system (GL) during a specified time interval (t) during operation; and ascertaining a current fill level of all tank vessels during the specified time interval by subtracting the ascertained dispensed mass of gaseous fuel from the stored fill level.

### BACKGROUND

The present invention relates to a method for ascertaining the fill level of a tank unit and a tank unit for storing a gaseous fuel.

In known accumulator tanks, safety devices and/or valves can be installed. Fuel cell systems having tank assemblies or tanks for gaseous media are known for this purpose. Pressurized storage tanks can be equipped with a valve to shut off or drain the tank contents.

In conventional H2 tank systems with a plurality of gas tanks, each equipped with its own tank valve, not necessarily all tanks are equipped with their own pressure sensor. A determination of the tank level at the tank and for a plurality of tanks after reaching the pressure equalization is desirable.

DE112006003013B4 describes a tank with a fitting and a valve, wherein the valve is fastened in the fitting.

### SUMMARY

The present invention provides a method for ascertaining the fill level of a tank unit and a tank unit for storing a gaseous fuel.

Preferred developments are the subject-matter of the dependent claims.

The idea underlying the present invention is to provide a method for ascertaining the fill level of a tank unit and a tank unit for storing a gaseous fuel, in which a storage state (SOC) of the tank unit can be determined more accurately.

Advantageously, avoidance and/or reduction of inaccuracies in determining the tank level in a plurality of tank vessels during operation and after vehicle startup, such as a fuel cell of the vehicle, may be achieved for different tank pressures, e.g., due to different tank heating/cooling while the vehicle is stationary.

According to the invention, the method for ascertaining the fill level of a tank unit having a plurality of tank vessels, each of which are connected to a gas pipe system by a respective valve mechanism that can be switched between an open state and a closed state, wherein the method comprises reading a fill level of all tank vessels out of a data memory, said fill level having been ascertained and stored during a preceding operation of a vehicle; switching the valve mechanisms from the closed state to the open state such that gas can flow from the tank vessels into the gas pipe system; ascertaining a mass of gaseous fuel dispensed from the gas pipe system during a specified time interval during operation; and ascertaining a current fill level of all tank vessels during the specified time interval by subtracting the ascertained dispensed mass of gaseous fuel from the stored fill level.

During a period of inactivity of a vehicle with a hydrogen storage system, it is possible that different pressures may develop in the individual tank vessels, which may result from different temperature changes in the individual tank vessels, for example due to different heating or cooling due to different tank designs or different ambient conditions.

It may be advantageous to carry out the aforementioned calculation of the tank fill level during a specified time after start-up until the pressure between the tank vessels has been completely equalized.

According to a preferred embodiment of the method, the specified time interval is only counted after all or at least one of the valve mechanisms has been opened.

The specified time interval may correspond to a time from the start-up of the vehicle (and the fuel cell) until the determined or estimated pressure equalization of the tank vessels.

According to a preferred embodiment of the method, the valve mechanisms of a plurality of tank vessels are opened when the vehicle is started, wherein a cumulative gas consumption dispensed during the specified time interval is determined by integrating the consumer mass flow over time since the valve mechanisms were opened.

The subtracted consumption of the consumer system, in other words the mass of gaseous fuel dispensed (for example by the fuel cell as a consumer), may be the cumulative gas consumption of the consumer system.

According to the invention, the tank unit for storing a gas fuel comprises a plurality of tank vessels into which the gaseous fuel can be filled; a gas pipe system; at least one valve mechanism per tank vessel, which connects the respective tank vessel to the gas pipe system, wherein the at least one valve mechanism being switchable between an open state, in which it connects the tank vessel in a fluidically conductive manner to the gas pipe system, and a closed state, in which it separates the respective tank vessel from the gas pipe system; a sensor device which is designed to capture a temperature in each tank and a gas pressure in the gas pipe system; and a control device which is connected to the sensor device and is configured to carry out a method.

The plurality of tank vessels can together with the gas pipe system form a gas storage system.

According to a preferred embodiment of the tank unit, the control device is configured to count the predetermined time only after the valve mechanisms on the tank vessels have been opened.

According to a preferred embodiment of the tank unit, it comprises a plurality of tank vessels which are connected to the gas pipe and to the sensor device.

According to a preferred embodiment of the tank unit, the control device is configured so as to open the valve mechanism of the tank vessels when the vehicle is put into service.

The gas pipe system can be used in order to supply the gaseous fuel to the tank vessels and also to remove the gas from the tank vessels towards the motor or fuel cell of the vehicle. The valve mechanism can comprise a closable valve, which can be electrically opened and closed. A pressure equalization between the tanks can be brought about by opening the tank valves and delivering gas to the supply line to the gas pipe system. The specified time until the assumed pressure equalization can be so long that when a plurality of tank vessels are opened after the vehicle's drive, such as the fuel cell or engine, has been started, the gas pressure in the gas pipe system and the tank vessels can be equalized. This means that high internal pressure in one tank vessel can release more gaseous fuel to the gas pipe than low internal pressure in another tank vessel until the internal pressures are equalized, at which point both (or several) can release the same quantities per unit of time.

The vehicle can be a fuel cell vehicle. The gaseous fuel can be a gaseous gas for the operation of a fuel cell, for example hydrogen or also other gases that are possible for this purpose. On the other hand, the gaseous fuel can also be a gas for a gas-powered vehicle, such as CNG or LPG, which can also be liquid gas.

The sensor device may comprise one or more sensors with which a reduction in pressure and/or a pressure gradient and/or a temperature gradient and/or a temperature in the tank vessel or the gas pipe system can be detected.

The control device can be connected to the valve mechanism of one or a plurality of tank vessels and to sensors and can read these.

The method can also be characterized by the features mentioned in connection with the tank unit and by the advantages thereof, and vice versa.

### BRIEF DESCRIPTION OF THE DRAWINGS

Further features and advantages of embodiments of the invention are apparent from the following description with reference to the accompanying drawings.

The present invention is explained in greater detail below with reference to the exemplary embodiments indicated in the figures of the drawing.

Shown are:

FIG. 1 a schematic illustration of a tank unit for storing a gaseous fuel according to an exemplary embodiment of the present invention.

### DETAILED DESCRIPTION

Identical reference signs in the figures denote identical or functionally identical elements.

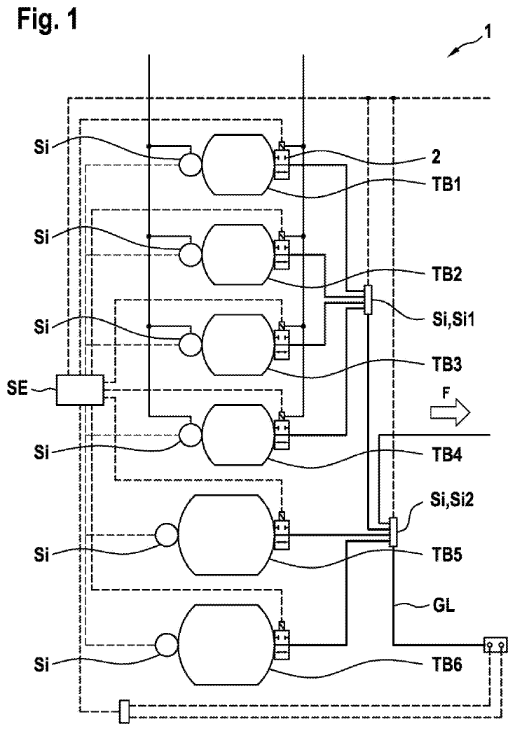

The tank unit 1 for storing a gaseous fuel for a vehicle F comprises, according to FIG. 1, a plurality of tank vessels TB1, TB2, TB3, TB4, TB5 and TB6, for example bottles that are or can be filled with hydrogen. The tank unit 1 comprises a valve mechanism 2, for example for each tank vessel, which is connected to the tank vessel or arranged on it, wherein the valve mechanism 2 is configured to admit and/or discharge the gaseous fuel into the tank vessels and/or to separate their tank contents. The tank unit 1 further comprises a gas pipe GL in a gas pipe system, which is connected to the at least one valve mechanism 2; and a control device SE and a sensor device Si by means of which a method according to the invention can be carried out, which is connected to the gas pipe GL and the at least one tank vessel or arranged therein and is configured to determine a gas pressure in the gas pipe GL and a gas temperature in the at least one tank vessel.

A temperature sensor Si may be provided on each of the tank vessels TB1 to TB6, which may be connected to the control device SE and read out by the latter. The temperature sensor allows the tank temperature of the respective tank vessel to be determined.

The sensor device Si may also comprise several sensors, for example a first sensor Si1, which can be connected to supply lines from the first three tank vessels (for example three, wherein this arrangement can also be different) and a second sensor Si2, which can be connected to the remaining supply lines and the gas pipe GL and are configured to determine a gas pressure in the gas pipe GL at a predetermined time. The method according to the invention for ascertaining pressure, pressure gradient or other parameters can be carried out on one or both or further sensors. The control device SE can be configured to count the predetermined time only after the vehicle has been started and/or to open the valve mechanisms 2 of the tank vessels (TB1, TB2, TB3, . . . ) after the vehicle has been started.

Although the present invention has been described in full with reference to the preferred embodiment, it is not limited thereto and can be modified in many ways.

1. A method for ascertaining a fill level of a tank unit having a plurality of tank vessels (TB), each of which are connected to a gas pipe system (GL) by a respective valve mechanism of multiple valve mechanisms that each can be switched between an open state and a closed state, wherein the method comprises:
reading a fill level of all tank vessels out of a data memory, said fill level having been ascertained and stored during a preceding operation of a vehicle;
switching the valve mechanisms from the closed state to the open state such that gas can flow from the tank vessels into the gas pipe system;
ascertaining a mass of gaseous fuel dispensed from the gas pipe system (GL) during a specified time interval (t) during operation; and
ascertaining a current fill level of all tank vessels during the specified time interval by subtracting the ascertained dispensed mass of gaseous fuel from the stored fill level.

2. The method according to claim 1, in which the specified time interval is counted only after opening at least one valve mechanism.

3. A method according to claim 1, wherein the valve mechanisms of a plurality of tank vessels are opened when the vehicle is started, wherein a cumulative gas consumption dispensed in the specified time interval (t) is determined by integrating a consumer mass flow over time since the valve mechanisms were opened.

4. A tank unit (1) for storing a gaseous fuel, comprising:
a plurality of tank vessels (TB) into which the gaseous fuel can be filled;
a gas pipe system;
at least one valve mechanism (2) per tank vessel, which connects the respective tank vessel to the gas pipe system (GL), wherein the at least one valve mechanism (2) is switchable between an open state, in which it connects the tank vessel in a fluidically conductive manner to the gas pipe system (GL), and a closed state, in which it separates the respective tank vessel from the gas pipe system; a sensor device
(Si) which is designed to capture a temperature in each tank and a gas pressure in the gas pipe system; and
a control device (SE) which is connected to the sensor device (Si) and is configured to
read a fill level of all tank vessels out of a data memory, said fill level having been ascertained and stored during a preceding operation of a vehicle;
control switching of the valve mechanisms from the closed state to the open state such that gas can flow from the tank vessels into the gas pipe system;
ascertain a mass of gaseous fuel dispensed from the gas pipe system (GL) during a specified time interval (t) during operation; and
ascertain a current fill level of all tank vessels during the specified time interval by subtracting the ascertained dispensed mass of gaseous fuel from the stored fill level.

5. The tank unit (1) according to claim 4, wherein the control device (SE) is configured to count the specified time interval only after the valve mechanisms on the tank vessels have been opened.

6. The tank unit (1) according to claim 4, comprising a plurality of tank vessels (TB1, TB2, TB3, . . . ) which are connected to the gas pipe (GL) and to the sensor device (Si).

7. The tank unit (1) according to claim 4, wherein the control device (SE) is configured to open the valve mechanisms (2) of the tank vessels (TB1, TB2, TB3, . . . ) when the vehicle is started.
